(19) United States
(12) Patent Application Publication
(10) Pub. No.: US 2026/0116760 A1
(43) Pub. Date: Apr. 30, 2026

(54) Porous Graphene Ball-Hosted Anode Active Materials for Lithium-ion and Sodium-ion Batteries

(71) Applicant: Honeycomb Battery Company, Dayton, OH (US)

(72) Inventors: Aruna Zhamu, Springboro, OH (US); Song-Hai Chai, Dayton, OH (US); Hao-Hsun Chang, Centerville, OH (US); Bor Z. Jang, Centerville, OH (US)

(73) Assignee: Honeycomb Battery Company, Dayton, OH (US)

(21) Appl. No.: 18/930,961

(22) Filed: Oct. 29, 2024

(51) Int. Cl. C01B 32/194; H01M 10/0525; H01M 10/36

(52) U.S. Cl. CPC C01B 32/194; H01M 10/0525; H01M 10/36; C01P 2002/08; C01P 2002/72; C01P 2004/32; C01P 2004/61; C01P 2004/62; C01P 2006/10; C01P 2006/12; C01P 2006/16

(57) ABSTRACT

Provided are a powder mass and a production process, the powder mass comprising multiple porous graphene balls for use in a lithium-ion or sodium-ion battery, wherein at least one of the graphene balls has a diameter from 100 nm to 20 μm and comprises (i) pores and pore walls therein, pore walls having a thickness from approximately 0.34 nm to 100 nm, and (ii) an anode active material residing in the pores or supported by the pore walls, and wherein (a) at least one of the pore walls comprises graphene domains dispersed in a disordered or amorphous carbon phase and a domain consists essentially of 1-100 graphene planes; and (b) the anode active material is in a form of particles or coating having a diameter or thickness from 0.5 nm to 10 μm, and in an amount of 0.1% to 95% of the total particulate weight.

### FIELD

This invention relates generally to an anode active material deposited in the pores of a porous graphene/carbon particulate host, a method of producing such a porous carbon/graphene-hosted anode active material composition, an anode comprising such a composition, and a lithium-ion or sodium-ion battery featuring such an anode.

### BACKGROUND

A unit cell or building block of a lithium-ion or sodium-ion battery is typically composed of an anode current collector, an anode or negative electrode layer (containing an anode active material responsible for storing lithium or sodium therein, a conductive additive, and a resin binder), an electrolyte and/or separator, a cathode or positive electrode layer (containing a cathode active material responsible for storing lithium or sodium therein, a conductive additive, and a resin binder), and a separate cathode current collector. The electrolyte is in ionic contact with both the anode active material and the cathode active material. A porous separator is not required if the electrolyte is a solid-state electrolyte.

The binder in the binder layer is used to bond the anode active material (e.g. graphite or Si particles) and a conductive filler (e.g. carbon black or carbon nanotube) together to form an anode layer of structural integrity, and to bond the anode layer to a separate anode current collector, which acts to collect electrons from the anode active material when the battery is discharged. In other words, in the negative electrode (anode) side of the battery, there are typically four different materials involved: an anode active material, a conductive additive, a resin binder (e.g., polyvinylidine fluoride, PVDF, or styrene-butadiene rubber, SBR), and an anode current collector (typically a sheet of Cu foil). Typically the former three materials form a separate, discrete anode layer and the latter one forms another discrete layer.

The most commonly used anode active materials for lithium-ion batteries are natural graphite and synthetic graphite (or artificial graphite) that can be intercalated with lithium and the resulting graphite intercalation compound (GIC) may be expressed as LiₓC₆, where x is typically less than 1. The maximum amount of lithium that can be reversibly intercalated into the interstices between graphene planes of a perfect graphite crystal corresponds to x=1, defining a theoretical specific capacity of 372 mAh/g.

Graphite or carbon anodes can have a long cycle life due to the presence of a protective solid-electrolyte interface layer (SEI), which results from the reaction between lithium and the electrolyte (or between lithium and the anode surface/edge atoms or functional groups) during the first several charge-discharge cycles. The lithium in this reaction comes from some of the lithium ions originally intended for the charge transfer purpose. As the SEI is formed, the lithium ions become part of the inert SEI layer and become irreversible, i.e. these positive ions can no longer be shuttled back and forth between the anode and the cathode during charges/discharges. Therefore, it is desirable to use a minimum amount of lithium for the formation of an effective SEI layer. In addition to SEI formation, the irreversible capacity loss Qᵢᵣ can also be attributed to graphite exfoliation caused by electrolyte/solvent co-intercalation and other side reactions.

In addition to carbon- or graphite-based anode materials, other inorganic materials that have been evaluated for potential anode applications include metal oxides, metal nitrides, metal sulfides, and the like, and a range of metals, metal alloys, and intermetallic compounds that can accommodate lithium atoms/ions or react with lithium. Among these materials, lithium alloys having a composition formula of LiₐA (A is a metal or semiconductor element, such as Al and Si, and “a” satisfies 0<a≤5) are of great interest due to their high theoretical capacity, e.g., Li₄Si (3,829 mAh/g), Li_{4.4}Si (4,200 mAh/g), Li_{4.4}Ge (1,623 mAh/g), Li_{4.4}Sn (993 mAh/g), Li₃Cd (715 mAh/g), Li₃Sb (660 mAh/g), Li_{4.4}Pb (569 mAh/g), LiZn (410 mAh/g), and Li₃Bi (385 mAh/g). However, as schematically illustrated in FIG. 2(A), in an anode composed of these high-capacity materials, severe pulverization (fragmentation of the alloy particles) occurs during the charge and discharge cycles due to severe expansion and contraction of the anode active material particles induced by the insertion and extraction of the lithium ions in and out of these particles. The expansion and contraction, and the resulting pulverization, of active material particles, lead to loss of contacts between active material particles and conductive additives and loss of contacts between the anode active material and its current collector. These adverse effects result in a significantly shortened charge-discharge cycle life.

To overcome the problems associated with such mechanical degradation, three technical approaches have been proposed:
(1) reducing the size of the active material particle, presumably for the purpose of reducing the total strain energy that can be stored in a particle, which is a driving force for crack formation in the particle. However, a reduced particle size implies a higher surface area available for potentially reacting with the liquid electrolyte to form a higher amount of SEI. Such a reaction is undesirable since it is a source of irreversible capacity loss.
(2) depositing the electrode active material in a thin film form directly onto a current collector, such as a copper foil. However, such a thin film structure with an extremely small thickness-direction dimension (typically much smaller than 500 nm, often necessarily thinner than 100 nm) implies that only a small amount of active material can be incorporated in an electrode (given the same electrode or current collector surface area), providing a low total lithium storage capacity and low lithium storage capacity per unit electrode surface area (even though the capacity per unit mass can be large). Such a thin film should have a thickness less than 100 nm to be more resistant to cycling-induced cracking, further diminishing the total lithium storage capacity and the lithium storage capacity per unit electrode surface area. Such a thin-film battery has very limited scope of application. A desirable and typical electrode thickness is from 100 μm to 200 μm. These thin-film electrodes (with a thickness of <500 nm or even <100 nm) fall short of the required thickness by three (3) orders of magnitude, not just by a factor of 3.
(3) using a composite composed of small electrode active particles protected by (dispersed in or encapsulated by) a less active or non-active matrix, e.g., carbon-coated Si particles, sol gel graphite-protected Si, metal oxide-coated Si or Sn, and monomer-coated Sn nano particles. Presumably, the protective matrix provides a cushioning effect for particle expansion or shrinkage, and prevents the electrolyte from contacting and reacting with the electrode active material. Examples of high-capacity anode active particles are Si, Sn, and SnO₂. Unfortunately, when an active material particle, such as Si particle, expands (e.g., up to a volume expansion of 380%) during the battery charge step, the protective coating is easily broken due to the mechanical weakness and/o brittleness of the protective coating materials. There has been no high-strength and high-toughness material available that is itself also lithium ion conductive.

It may be further noted that the coating or matrix materials used to protect active particles (such as Si and Sn) are carbon, sol gel graphite, metal oxide, polymer, ceramic, and lithium oxide. These protective materials are all very brittle, weak (of low strength), and/or non-conducting (e.g., ceramic or oxide coating). Ideally, the protective material should meet the following requirements: (a) The coating or matrix material should be of high strength and stiffness so that it can help to refrain the electrode active material particles, when lithiated, from expanding to an excessive extent. (b) The protective material should also have high fracture toughness or high resistance to crack formation to avoid disintegration during repeated cycling. (c) The protective material should be inert (inactive) with respect to the electrolyte, but be a good lithium ion conductor. (d) The protective material should not provide any significant amount of defect sites that irreversibly trap lithium ions. (e) The protective material should be lithium ion-conducting as well as electron-conducting. The prior art protective materials all fall short of these requirements. Hence, it was not surprising to observe that the resulting anode typically shows a reversible specific capacity much lower than expected. In many cases, the first-cycle efficiency is extremely low (mostly lower than 80% and some even lower than 60%). Furthermore, in most cases, the electrode was not capable of operating for a large number of cycles. Additionally, most of these electrodes are not high-rate capable, exhibiting unacceptably low capacity at a high discharge rate.

Due to these and other reasons, most of prior art composite electrodes and electrode active materials have deficiencies in some ways, e.g., in most cases, less than satisfactory reversible capacity, poor cycling stability, high irreversible capacity, ineffectiveness in reducing the internal stress or strain during the lithium ion insertion and extraction steps, and other undesirable side effects.

Complex composite particles of particular interest are a mixture of separate Si and graphite particles dispersed in a carbon matrix; e.g., those prepared by Mao, et al. [“Carbon-coated Silicon Particle Powder as the Anode Material for Lithium Batteries and the Method of Making the Same,” US 2005/0136330 (Jun. 23, 2005)]. Also of interest are carbon matrix-containing complex nano Si (protected by oxide) and graphite particles dispersed therein, and carbon-coated Si particles distributed on a surface of graphite particles Again, these complex composite particles led to a low specific capacity or for up to a small number of cycles only. It appears that carbon by itself is relatively weak and brittle and the presence of micron-sized graphite particles does not improve the mechanical integrity of carbon since graphite particles are themselves relatively weak. Graphite was used in these cases presumably for the purpose of improving the electrical conductivity of the anode material. Furthermore, certain carbon materials may have too many lithium-trapping sites that irreversibly capture lithium during the first few cycles, resulting in excessive irreversibility.

In summary, the prior art has not demonstrated a composite material that has all or most of the properties desired for use as an anode active material in a lithium-ion battery. Similar situations hold true for sodium-ion batteries. Thus, there is an urgent and continuing need for a new anode active material that enables a lithium-ion or sodium-ion battery to exhibit a high cycle life, high reversible capacity, low irreversible capacity, small particle sizes (for high-rate capacity), and compatibility with commonly used electrolytes. There is also a need for a method of readily or easily producing such a material in large quantities.

Thus, it is an object of the present invention to meet these needs and address the issues associated the rapid capacity decay of a lithium-ion or sodium-ion battery containing a high-capacity anode active material.

### SUMMARY

The aforementioned issues can be resolved by the presently disclosed porous graphene/anode material composite and its production method. In certain embodiments, the disclosure provides a porous powder mass comprising multiple porous graphene balls (or particulates) for use in a lithium-ion battery or sodium-ion battery, wherein at least one or all of the graphene balls (particulates) has a diameter from 100 nm to 20 μm (preferably from 500 nm to 10 μm) and comprises (i) pores and pore walls therein, wherein the pore walls have a wall thickness from approximately 0.34 nm to 100 nm (preferably less than 30 nm), and (ii) an anode active material residing in the pores or supported by the pore walls, and wherein (a) at least one of the pore walls comprises one or a plurality of graphene domains dispersed in a disordered or amorphous carbon phase and a domain typically consists of essentially 1-100 graphene planes stacked together (more typically 2-20 graphene planes); and (b) the anode active material is in a form of particles or coating having a diameter or thickness from 0.5 nm to 10 μm, and in an amount of 0.1% to 95% of the total particulate weight (composite weight).

In certain embodiments, a graphene domain contains from 1 to 20 stacked graphene planes having an inter-plane spacing d₀₀₂ from 0.3354 nm to 2.0 nm (typically less than 0.6 nm, more typically less than 0.45 nm, and most desirably less than 0.344 nm) as measured by X-ray diffraction and the graphene planes comprise 0% to 25% by weight of non-carbon elements. The non-carbon elements are typically selected from the group consisting of O, H, N, F, Cl, Br, B, S, P, and combinations thereof.

In certain preferred embodiments, the anode active material (such as Si, Ge, Sn, P, Al, Bi, SnO₂, and SiOₓ, 0.1<x<1.9) comprises clusters having a diameter or thickness from 0.5 to 10 nm that are coated on pore walls.

The anode active material may be selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobium oxide, lithium-containing titanium oxide, lithium transition metal oxide, ZnCo₂O₄; (f) carbon or graphite particles; (g) prelithiated versions thereof; and (h) combinations thereof.

Typically, the pores have a pore size from 5 nm to 10 μm and the porous graphene balls have a porosity level from 10% to 99% prior to hosting the anode active material. Preferably, the pores are interconnected and the porous graphene balls have a porosity level from 50% to 95% in the absence of an anode active material.

In some embodiments, one or a plurality of anode active material particles, having a total volume Va, resides in the pores having a pore volume Vp and the Vp/Va ratio is from 1.2 to 5.0, preferably from 1.5 to 4.0.

In certain embodiments, a graphene ball is encapsulated or coated with a coating material that is electron-conducting, ion-conducting, or both electron-and ion-conducting. The electron-conducting material may be selected from an intrinsically conducting polymer, a pitch, an amorphous carbon, a metal, or a combination thereof.

Preferably, the coating material comprises an electron-conducting, lithium ion-conducting, or sodium ion-conducting material. The electron-conducting material may be selected from an intrinsically conducting polymer, a pitch, an amorphous carbon, a metal, or a combination thereof. The intrinsically conducting polymer is preferably selected from polyacetylene, polythiophene, poly(3-alkylthiophenes), polypyrrole, polyaniline, polyfuran, a bi-cyclic polymer, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof.

In the porous graphene balls, the lithium ion-conducting material (i) may be selected from a material comprising Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, x=0-1, y=1-4; (ii) may contains a lithium salt selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato) borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, or a combination thereof.

The lithium ion- or sodium ion-conducting material preferably comprises a lithium ion-conducting or sodium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, poly bis-methoxy ethoxyethoxide-phosphazenex, polyphosphazene, cyanoethyl poly(vinyl alcohol), a pentaerythritol tetra-acrylate-based polymer, an aliphatic polycarbonate, a single Li-ion conducting solid polymer, poly(ethylene glycol) diacrylate, poly(ethylene glycol) methyl ether acrylate, polyurethane, polyurethane-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a semi-penetrating network thereof, a sulfonated derivative thereof, or a combination thereof.

The graphene balls may further contain an electron-conducting material dispersed in the pores and selected from an expanded graphite flake, carbon nanotube, carbon nanofiber, carbon fiber, carbon particle, graphite particle, carbon black, acetylene black, pitch, an electron-conducting polymer, or a combination thereof.

The graphene ball or particulate in the powder mass, when measured without any anode material, preferably has a density from 0.005 to 1.7 g/cm³ and a specific surface area from 50 to 2,630 m²/g. In certain embodiments, the graphene particulate, when measured without any anode material, has a density from 0.1 to 1.7 g/cm³ and has some pores with an average pore size from 10 nm to 10 μm. The pores are preferably interconnected to facilitate the entry of an anode active material. In some embodiments, the particulate has a physical density higher than 0.8 g/cm³ and a specific surface area greater than 600 m²/g. In some embodiments, the graphene particulate has a physical density higher than 1.0 g/cm³ and a specific surface area greater than 300 m²/g.

The present disclosure also provides an alkali metal-ion battery anode comprising the disclose powder mass as an anode material. Also disclosed is an alkali metal-ion battery that comprises a cathode, the herein disclosed anode, and an electrolyte in ionic contact with both the cathode and the anode.

In some embodiments, the lithium ion-conducting material in the graphene ball comprises a sulfonated polymer, which is typically conductive to lithium ions or sodium ions.

The present disclosure further provides a process for producing the disclosed powder mass, the process comprising (A) producing porous graphene balls, having pores and pore walls therein, by activating, carbonizing, and partially graphitizing a carbonaceous feedstock selected from biochar, bio-pitch, petroleum pitch, coal tar pitch, petroleum coke, coal-derived coke, carbonized pitch, meso-phase pitch, meso-carbon micro-beads (MCMB), needle coke, soft carbon, hard carbon, activated carbon, carbon fibers, or a combination thereof, wherein partial graphitization refers to a product either (i) exhibiting a degree of graphitization, g, less than 100% but greater than 0%, wherein g=(3.440−d₀₀₂)/(3.440−3.354), where 3.440 is a reference inter-planar spacing in a graphite material with a turbostratic structure; d₀₀₂, with a unit Angstrom (1 Å=0.1 nm), is the value of interlayer spacing of a partially graphitized product obtained by X-ray diffraction and d₀₀₂ is no greater than 3.440 Å, or (ii) having a interlayer spacing in the range of 3.440 <d₀₀₂<20 Å (preferably <10 Å), wherein the carbonaceous feedstock is in a particle form having a size smaller than 1 mm, preferably smaller than 100 μm, before or after the activating, carbonizing, and partially graphitizing procedure; and (B) impregnating or infiltrating an anode active material into pores of the porous graphene balls to form the powder mass

The “degree of graphitization” refers to a measure of how closely a carbon material resembles the ideal crystalline structure of graphite, essentially indicating the extent to which a carbon material has transformed into a well-ordered graphite structure, usually quantified by analyzing the interplanar spacing between graphene layers using X-ray diffraction (XRD) and comparing it to the spacing in perfect graphite; a higher degree of graphitization means the material is more similar to ideal graphite with a higher level of structural order.

The degree of graphitization is primarily determined using XRD analysis, where the “d₀₀₂” spacing (distance between graphene layers) is measured and compared to the ideal graphite value to calculate a graphitization degree. In a commonly used method (when d₀₀₂ being no greater than 3.440 Å or 0.3440 nm), the graphitization degree can be calculated by the following formula: g=(3.440−d₀₀₂)/(3.440−3.354), wherein g is the graphitization degree of a graphitic product, such as a partially graphitized carbon; 3.440 is inter-planar spacing in a carbon/graphite product with a turbostratic structure; d₀₀₂ is the value of interlayer spacing of the tested graphite obtained by XRD.

A higher degree of graphitization indicates a more ordered, crystalline graphite-like structure, while a lower degree suggests a more disordered, amorphous carbon structure. The degree of graphitization is influenced by the heat treatment temperature and time during the graphitization process, with higher temperatures and longer periods of time leading to a higher degree of graphitization.

When d₀₀₂ is greater than 3.440 Å or 0.3440 nm, a carbonaceous material may also be referred to as a partially graphitized material if the material contains graphene domains dispersed in an disordered carbon matrix.

In some embodiments, Step (A) of producing graphene balls comprises a procedure selected from (i) carbonization of a feedstock followed by activation and partial graphitization; (ii) concurrent carbonization and activation of the feedstock followed by partial graphitization; or (iii) carbonization and partial graphitization followed by activation, wherein the degree of graphitization prior to activation is from 5% to 90%, preferably from 10% to 70%.

Step (B) of impregnating or infiltrating an anode active material into pore may comprise a procedure selected from physical vapor deposition, plasma-enhanced physical vapor deposition, chemical vapor deposition, plasma-enhanced chemical vapor deposition, electrochemical deposition, liquid solution deposition, sputtering, or a combination thereof.

In some preferred embodiments, the process further comprises a step of encapsulating the graphene balls, after step (B), with a coating material that is electron-conducting, ion-conducting, or both electron-and ion-conducting. The encapsulating step may comprise a procedure selected from spray drying, spray cooling, pan-coating, air-suspension coating, fluidized-bed coating, freeze-drying, centrifugal extrusion, vibration nozzle coating, hydrothermal encapsulation, supercritical fluid coating, or in-situ polymerization.

The process may further comprise a step of incorporating the powder mass in an anode (negative electrode) for a lithium-ion or sodium-ion battery and then combining a cathode, a separator, and an anode together to form such a battery.

### BRIEF DESCRIPTION OF THE DRAWINGS

FIG. 1(A) Schematic of a prior art lithium-ion battery cell, wherein the anode layer is a thin coating of an anode active material itself.

FIG. 1(B) Schematic of another prior art lithium-ion battery; the anode layer being composed of particles of an anode active material, a conductive additive (not shown) and a resin binder (not shown).

FIG. 2(A) Schematic illustrating the notion that expansion of Si particles in a prior art negative electrode (anode), upon lithium intercalation during charging of a prior art lithium-ion battery, can lead to pulverization of Si particles, interruption of the conductive paths formed by the conductive additive, and loss of contact with the current collector;

FIG. 2(B) illustrates the issues associated with prior art anode active material; for instance, a non-lithiated Si particle encapsulated by a protective shell (e.g., carbon shell) in a core-shell structure inevitably leads to breakage of the shell and that a pre-lithiated Si particle encapsulated with a protective layer leads to poor contact between the contracted Si particle and the rigid protective shell during battery discharge.

FIG. 3 A flow chart showing a presently invented process for producing porous graphene balls directly from a carbonaceous feedstock material wherein the graphene pores have an anode active material residing in the pores or supported on pore wall comprising graphene domains according to some embodiments of the present disclosure.

FIG. 4 Schematic of a graphene ball according to some embodiments of the present disclosure; the graphene ball or particulate containing particles or coating of an anode active material residing in pores or supported on graphene domain-containing pore walls according to some embodiments of the present disclosure.

### DETAILED DESCRIPTION

This disclosure provides an anode (negative electrode) comprising porous graphene-based composite particulates (each having one or more than one anode active material particles dispersed in the pores or deposited on graphene-based pore walls) for a lithium secondary battery, which is preferably a secondary battery based on a non-aqueous electrolyte, a polymer gel electrolyte, an ionic liquid electrolyte, a quasi-solid electrolyte, a polymer solid electrolyte, an inorganic solid-state electrolyte, or a composite or hybrid electrolyte. The shape of a lithium secondary battery can be cylindrical, square, button-like, etc. The present disclosure is not limited to any battery shape or configuration or any type of electrolyte. For convenience, we will primarily use Si, Sn, and SnO₂ as illustrative examples of a high-capacity anode active material. This should not be construed as limiting the scope of the invention.

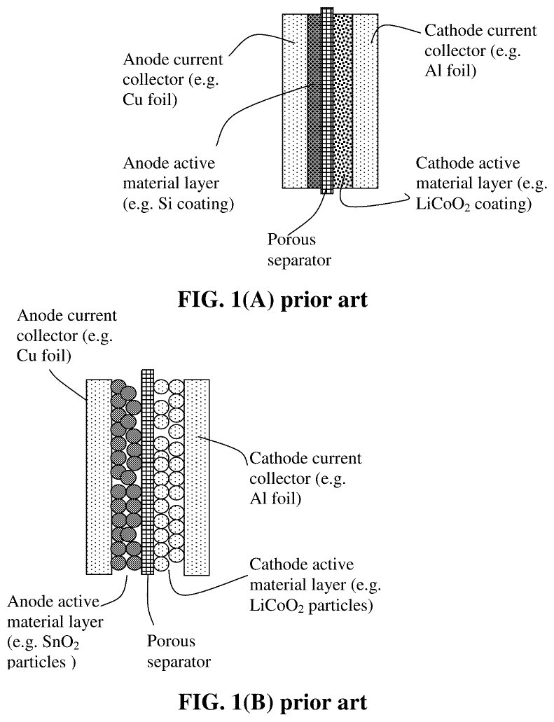

As illustrated in FIG. 1(B), a lithium-ion battery cell is typically composed of an anode current collector (e.g. Cu foil), an anode or negative electrode active material layer (i.e. anode layer typically containing particles of an anode active material, conductive additive, and binder), a porous separator and/or an electrolyte component, a cathode or positive electrode active material layer (containing a cathode active material, conductive additive, and resin binder), and a cathode current collector (e.g. Al foil). More specifically, the anode layer is composed of particles of an anode active material (e.g. graphite, Sn, SnO₂, or Si), a conductive additive (e.g. carbon black particles), and a resin binder (e.g. SBR or PVDF). This anode layer is typically 50-300 μm thick (more typically 100-200 μm) to give rise to a sufficient amount of current per unit electrode area.

In a less commonly used cell configuration, as illustrated in FIG. 1(A), the anode active material is deposited in a thin film form directly onto an anode current collector, such as a layer of Si coating deposited on a sheet of copper foil. This is not commonly used in the battery industry and, hence, will not be discussed further.

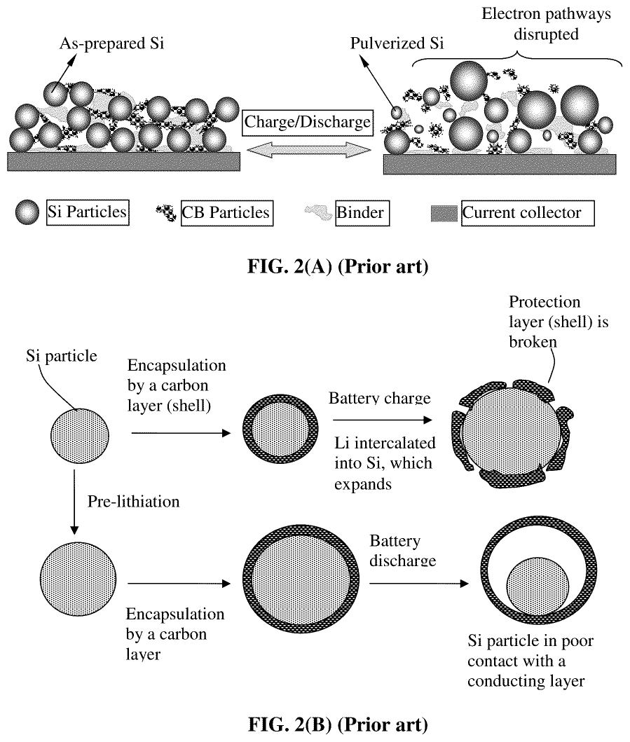

In order to obtain a higher energy density cell, the anode in FIG. 1(B) can be designed to contain higher-capacity anode active materials having a composition formula of LiₐA (A is a metal or semiconductor element, such as Al and Si, and “a” satisfies 0<a≤5). These materials are of great interest due to their high theoretical capacity, e.g., Li₄Si (3,829 mAh/g), Li_{4.4}Si (4,200 mAh/g), Li_{4.4}Ge (1,623 mAh/g), Li_{4.4}Sn (993 mAh/g), Li₃Cd (715 mAh/g), Li₃Sb (660 mAh/g), Li_{4.4}Pb (569 mAh/g), LiZn (410 mAh/g), and Li₃Bi (385 mAh/g). However, as discussed in the Background section, there are several problems associated with the implementation of these high-capacity anode active materials:
1) As schematically illustrated in FIG. 2(A), in an anode composed of these high-capacity materials, severe pulverization (fragmentation of the alloy particles) occurs during the charge and discharge cycles due to severe expansion and contraction of the anode active material particles induced by the insertion and extraction of the lithium ions in and out of these particles. The expansion and contraction, and the resulting pulverization, of active material particles, lead to loss of contacts between active material particles and conductive additives and loss of contacts between the anode active material and its current collector. These adverse effects result in a significantly shortened charge-discharge cycle life.
2) The approach of using a composite composed of small electrode active particles protected by (dispersed in or encapsulated by) a less active or non-active matrix, e.g., carbon-coated Si particles, sol gel graphite-protected Si, metal oxide-coated Si or Sn, and monomer-coated Sn nano particles, has failed to overcome the capacity decay problem. Presumably, the protective matrix provides a cushioning effect for particle expansion or shrinkage, and prevents the electrolyte from contacting and reacting with the electrode active material. Unfortunately, when an active material particle, such as Si particle, expands (e.g. up to a volume expansion of 380%) during the battery charge step, the protective coating is easily broken due to the mechanical weakness and/o brittleness of the protective coating materials. There has been no high-strength and high-toughness material available that is itself also lithium ion conductive.
3) The approach of using a core-shell structure (e.g., Si nano particle encapsulated in a carbon or SiO₂ shell) also has not solved the capacity decay issue. As illustrated in upper portion of FIG. 2(B), a non-lithiated Si particle can be encapsulated by a carbon shell to form a core-shell structure (Si core and carbon or SiO₂ shell in this example). As the lithium-ion battery is charged, the anode active material (carbon- or SiO₂-encapsulated Si particle) is intercalated with lithium ions and, hence, the Si particle expands. Due to the brittleness of the encapsulating shell (carbon), the shell is broken into segments, exposing the underlying Si to electrolyte and subjecting the Si to undesirable reactions with electrolyte during repeated charges/discharges of the battery. These reactions continue to consume the electrolyte and reduce the cell's ability to store lithium ions.
4) Referring to the lower portion of FIG. 2(B), wherein the Si particle has been pre-lithiated with lithium ions; i.e. has been pre-expanded in volume. When a layer of carbon (as an example of a protective material) is encapsulated around the pre-lithiated Si particle, another core-shell structure is formed. However, when the battery is discharged and lithium ions are released (de-intercalated) from the Si particle, the Si particle contracts, leaving behind a large gap between the protective shell and the Si particle. Such a configuration is not conducive to lithium intercalation of the Si particle during the subsequent battery charge cycle due to the gap and the poor contact of Si particle with the protective shell (through which lithium ions can diffuse). This would significantly curtail the lithium storage capacity of the Si particle particularly under high charge rate conditions.

In other words, there are several conflicting factors that should be considered concurrently when it comes to the design and selection of an anode active material in terms of material type, shape, size, porosity, and electrode layer thickness. Thus far, there has been no effective solution offered by any prior art teaching to these conflicting problems. We have solved these challenging issues that have troubled battery designers and electrochemists alike for more than 30 years by developing the multi-functional composite particulates.

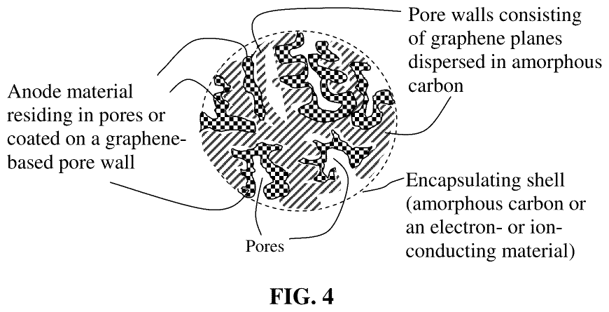

The disclosure provides a porous powder mass comprising multiple porous graphene balls (or particulates) for use in a lithium-ion battery or sodium-ion battery, wherein at least one or all of the graphene balls (particulates) has a diameter from 100 nm to 20 μm (preferably from 500 nm to 10 μm) and comprises (i) pores and pore walls therein, wherein the pore walls have a wall thickness from approximately 0.34 nm to 100 nm (preferably less than 30 nm), and (ii) an anode active material residing in the pores or supported by the pore walls, and wherein (a) at least one of the pore walls comprises one or a plurality of graphene domains dispersed in a disordered or amorphous carbon phase and a domain typically consists of essentially 1-100 graphene planes stacked together; and (b) the anode active material is in a form of particles or coating having a diameter or thickness from 0.5 nm to 10 μm, and in an amount of 0.1% to 95% of the total particulate weight (composite weight). The terms “graphene particulates” and “graphene balls” are herein used interchangeably. The graphene ball is schematically illustrated in FIG. 4, according to certain embodiments of the present disclosure.

In certain embodiments, a graphene domain contains from 1 to 20 stacked graphene planes having an inter-plane spacing d₀₀₂ from 0.3354 nm to 2.0 nm (typically less than 0.6 nm, more typically less than 0.45 nm, and most desirably less than 0.344 nm) as measured by X-ray diffraction and the graphene planes comprise 0% to 25% by weight of non-carbon elements. The non-carbon elements are typically selected from the group consisting of O, H, N, F, Cl, Br, B, S, P, and combinations thereof.

In certain preferred embodiments, the anode active material (such as Si, Ge, Sn, P, Al, Bi, SnO₂, and SiOₓ, 0.1<x<1.9) comprises clusters having a diameter or thickness from 0.5 to 10 nm that are coated on pore walls.

The anode active material may be selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobium oxide, lithium-containing titanium oxide, lithium transition metal oxide, ZnCo₂O₄; (f) carbon or graphite particles; (g) prelithiated versions thereof; and (h) combinations thereof.

Typically, the pores have a pore size from 5 nm to 10 μm and the porous graphene balls have a porosity level from 10% to 99% prior to hosting the anode active material. Preferably, the pores are interconnected and the porous graphene balls have a porosity level from 50% to 95% in the absence of an anode active material.

In some embodiments, one or a plurality of anode active material particles, having a total volume Va, resides in the pores having a pore volume Vp and the Vp/Va ratio is from 1.2 to 5.0, preferably from 1.5 to 4.0.

In certain embodiments, a graphene ball is encapsulated or coated with a coating material that is electron-conducting, ion-conducting, or both electron-and ion-conducting. The electron-conducting material may be selected from an intrinsically conducting polymer, a pitch, an amorphous carbon, a metal, or a combination thereof.

Preferably, the coating material comprises an electron-conducting, lithium ion-conducting, or sodium ion-conducting material. The electron-conducting material may be selected from an intrinsically conducting polymer, a pitch, an amorphous carbon, a metal, or a combination thereof. The intrinsically conducting polymer is preferably selected from polyacetylene, polythiophene, poly(3-alkylthiophenes), polypyrrole, polyaniline, polyfuran, a bi-cyclic polymer, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof.

In the porous graphene balls, the lithium ion-conducting material (i) may be selected from a material comprising Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, x=0-1, y=1-4; (ii) may contains a lithium salt selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato) borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, or a combination thereof. These lithium salts and similar sodium salts may also be used as part of an electrolyte for a lithium-ion or sodium-ion battery.

The lithium ion- or sodium ion-conducting material preferably comprises a lithium ion-conducting or sodium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, poly bis-methoxy ethoxyethoxide-phosphazenex, polyphosphazene, cyanoethyl poly(vinyl alcohol), a pentaerythritol tetra-acrylate-based polymer, an aliphatic polycarbonate, a single Li-ion conducting solid polymer, poly(ethylene glycol) diacrylate, poly(ethylene glycol) methyl ether acrylate, polyurethane, polyurethane-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a semi-penetrating network thereof, a sulfonated derivative thereof, or a combination thereof.

The graphene balls may further contain an electron-conducting material dispersed in the pores and selected from an expanded graphite flake, carbon nanotube, carbon nanofiber, carbon fiber, carbon particle, graphite particle, carbon black, acetylene black, pitch, an electron-conducting polymer, or a combination thereof.

The graphene ball or particulate in the powder mass, when measured without any anode material, preferably has a density from 0.005 to 1.7 g/cm³ and a specific surface area from 50 to 2,630 m²/g. In certain embodiments, the graphene particulate, when measured without any anode material, has a density from 0.1 to 1.7 g/cm³ and has some pores with an average pore size from 10 nm to 10 μm. The pores are preferably interconnected to facilitate the entry of an anode active material. In some embodiments, the particulate has a physical density higher than 0.8 g/cm³ and a specific surface area greater than 600 m²/g. In some embodiments, the graphene particulate has a physical density higher than 1.0 g/cm³ and a specific surface area greater than 300 m²/g.

The present disclosure also provides an alkali metal-ion battery anode comprising the disclose powder mass as an anode material. Also disclosed is an alkali metal-ion battery that comprises a cathode, the herein disclosed anode, and an electrolyte in ionic contact with both the cathode and the anode.

In some embodiments, the lithium ion-conducting material in the graphene ball comprises a sulfonated polymer, which is typically conductive to lithium ions or sodium ions.

The stacked graphene planes may have an inter-plane spacing d₀₀₂ from 0.335 nm to 0.6 nm as measured by X-ray diffraction. An inter-plane spacing d₀₀₂ higher than 0.34 nm can be achieved by intercalating a chemical species (e.g., Na, Li, K, F, Cl, N, B atoms, O₂ molecules, —OH group, etc.) into inter-planar spaces.

The present disclosure further provides a process for producing the disclosed powder mass, the process comprising (A) producing porous graphene balls, having pores and pore walls therein, by activating, carbonizing, and partially graphitizing a carbonaceous feedstock selected from biochar, bio-pitch, petroleum pitch, coal tar pitch, petroleum coke, coal-derived coke, carbonized pitch, meso-phase pitch, meso-carbon micro-beads (MCMB), needle coke, soft carbon, hard carbon, activated carbon, carbon fibers, or a combination thereof, wherein partial graphitization refers to a product either (i) exhibiting a degree of graphitization, g, less than 100% but greater than 0%, wherein g=(3.440−d₀₀₂)/(3.440−3.354), where 3.440 is a reference inter-planar spacing in a graphite material with a turbostratic structure; d₀₀₂, with a unit Angstrom (1 Å=0.1 nm), is the value of interlayer spacing of a partially graphitized product obtained by X-ray diffraction and d₀₀₂ is no greater than 3.440 Å, or (ii) having a interlayer spacing in the range of 3.440<d₀₀₂<20 Å (preferably <10 Å), wherein the carbonaceous feedstock is in a particle form having a size smaller than 1 mm, preferably smaller than 100 μm, before or after the activating, carbonizing, and partially graphitizing procedure; and (B) impregnating or infiltrating an anode active material into pores of the porous graphene balls to form the powder mass

The “degree of graphitization” refers to a measure of how closely a carbon material resembles the ideal crystalline structure of graphite, essentially indicating the extent to which a carbon material has transformed into a well-ordered graphite structure, usually quantified by analyzing the interplanar spacing between graphene layers using X-ray diffraction (XRD) and comparing it to the spacing in perfect graphite; a higher degree of graphitization means the material is more similar to ideal graphite with a higher level of structural order.

The degree of graphitization is primarily determined using XRD analysis, where the “d₀₀₂” spacing (distance between graphene layers) is measured and compared to the ideal graphite value to calculate a graphitization degree. In a commonly used method (with d₀₀₂ being no greater than 3.440 Å or 0.3440 nm), the graphitization degree can be calculated by the following formula: g=(3.440−d₀₀₂)/(3.440−3.354), wherein g is the graphitization degree of a graphitic product, such as a partially graphitized carbon; 3.440 is inter-planar spacing in a carbon/graphite product with a turbostratic structure; d₀₀₂ is the value of interlayer spacing of the tested graphite obtained by XRD.

A higher degree of graphitization indicates a more ordered, crystalline graphite-like structure, while a lower degree suggests a more disordered, amorphous carbon structure. The degree of graphitization is influenced by the heat treatment temperature and time during the graphitization process, with higher temperatures and longer periods of time leading to a higher degree of graphitization.

When d₀₀₂ is greater than 3.440 Å or 0.3440 nm, a carbonaceous material may also be referred to as a partially graphitized material if the material contains graphene domains dispersed in a disordered carbon matrix.

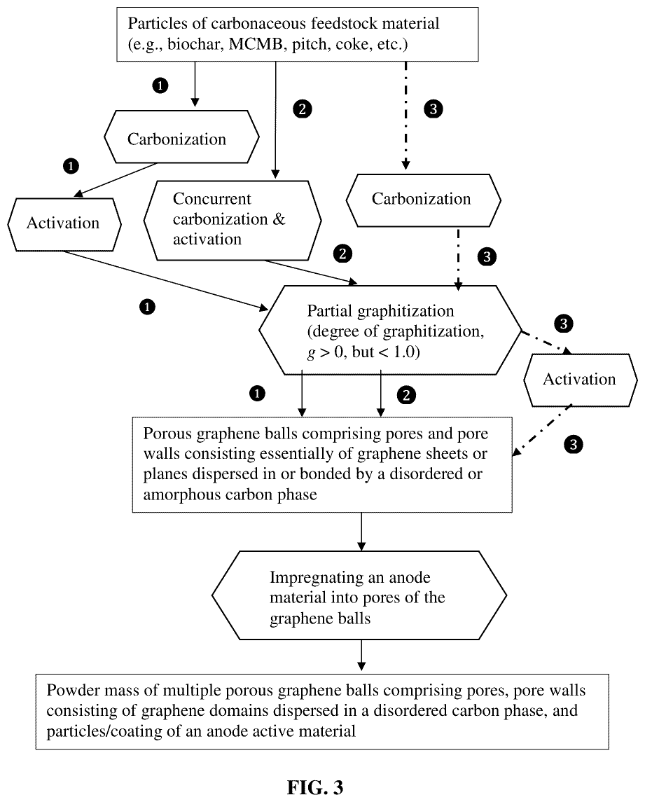

In some embodiments, Step (A) of producing graphene balls comprises a procedure selected from (i) carbonization of a feedstock followed by activation and partial graphitization (Route 1 in FIG. 3)); (ii) concurrent carbonization and activation of the feedstock followed by partial graphitization (Route 2 in FIG. 3)); or (iii) carbonization and partial graphitization followed by activation (Route 3 in FIG. 3)), wherein the degree of graphitization prior to activation is from 5% to 90%, preferably from 10% to 70%. Partial graphitization tends to increase the structural integrity, pore sizes, thermal conductivity and electrical conductivity; these features are essential to the success of graphene balls serving as a stable and reliable host for an anode active material.

In some preferred embodiments, the process further comprises a step of encapsulating the graphene balls, after step (B), with a coating material that is electron-conducting, ion-conducting, or both electron-and ion-conducting. The encapsulating step may comprise a procedure selected from spray drying, spray cooling, pan-coating, air-suspension coating, fluidized-bed coating, freeze-drying, centrifugal extrusion, vibration nozzle coating, hydrothermal encapsulation, supercritical fluid coating, or in-situ polymerization.

The process may further comprise a step of incorporating the powder mass in an anode (negative electrode) for a lithium-ion battery and then combining a cathode, a separator, and an anode to form a battery.

There are three broad categories of methods that can be implemented to encapsulate graphene balls or particulates. These include physical methods, physico-chemical methods, and chemical methods. The physical methods include pan-coating, air-suspension coating, centrifugal extrusion, vibration nozzle coating, and spray-drying methods. The physico-chemical methods include ionotropic gelation and coacervation-phase separation methods. The chemical methods include interfacial polycondensation, interfacial cross-linking, in-situ polymerization, and matrix polymerization. Several preferred processes are briefly discussed below:
Pan-coating method: The pan coating process involves tumbling a mixture of graphene balls, an optional adhesive, and an optional conductive additive in a pan or a similar device while the encapsulating material (e.g. a monomer/oligomer, polymer melt, or polymer/solvent solution) is applied slowly until a desired encapsulating shell thickness is attained.
Air-suspension coating method: In the air suspension coating process, a mixture of graphene balls, an optional adhesive, and an optional conductive additive is dispersed into the supporting air stream in an encapsulating chamber. A controlled stream of a suspension comprising graphene balls dispersed in a polymer-solvent solution (e.g. polymer or its monomer or oligomer dissolved in a solvent; or its monomer or oligomer alone in a liquid state) is concurrently introduced into this chamber, allowing the solution to hit and coat the suspended mixture particles. These suspended particles are coated with polymer (or oligomers, etc.) while the volatile solvent is removed, producing balls of polymer-encapsulated graphene balls.
Vibrational nozzle encapsulation method: Graphene balls can be conducted using a laminar flow through a nozzle and vibration of the nozzle or the liquid. The vibration has to be done in resonance with the Rayleigh instability, leading to very uniform droplets. The liquid can include any liquids with limited viscosities (1-50,000 mPa·s): emulsions, suspensions or slurry containing the polymer or its precursor dispersed or dissolved in a liquid medium.
Spray-drying: Spray drying may be used to encapsulate graphene balls from a suspension comprising multiple graphene balls suspended in a liquid medium or a polymer solution. In spray drying, the liquid feed (solution or suspension) is atomized to form droplets which, upon contacts with hot gas, allow solvent to get vaporized and graphene balls are coated with a polymer it its precursor. The precursor is then cured.

Electrolyte is an important ingredient in a battery. A wide range of electrolytes can be used for practicing the instant invention. Most preferred are non-aqueous liquid, polymer gel, solid polymer, in organic solid-state electrolytes, and composite/hybrid solid electrolytes although other types can be used. Polymer, polymer gel, and solid-state electrolytes are preferred over liquid electrolyte.

The non-aqueous electrolyte to be employed herein may be produced by dissolving an electrolytic salt in a non-aqueous solvent. Any known non-aqueous solvent which has been employed as a solvent for a lithium secondary battery can be employed. A non-aqueous solvent mainly including a mixed solvent comprising ethylene carbonate (EC) and at least one kind of non-aqueous solvent whose melting point is lower than that of aforementioned ethylene carbonate and whose donor number is 18 or less (hereinafter referred to as a second solvent) may be preferably employed. This non-aqueous solvent is advantageous in that it is (a) effective in suppressing the reductive or oxidative decomposition of electrolyte; and (b) high in conductivity. A non-aqueous electrolyte solely composed of ethylene carbonate (EC) is advantageous in that it is relatively stable against carbonaceous filament materials. However, the melting point of EC is relatively high, 39 to 40° C., and the viscosity thereof is relatively high, so that the conductivity thereof is low, thus making EC alone unsuited for use as a secondary battery electrolyte to be operated at room temperature or lower. The second solvent to be used in a mixture with EC functions to make the viscosity of the solvent mixture lower than that of EC alone, thereby promoting the ion conductivity of the mixed solvent. Furthermore, when the second solvent having a donor number of 18 or less (the donor number of ethylene carbonate is 16.4) is employed, the aforementioned ethylene carbonate can be easily and selectively solvated with lithium ion, so that the reduction reaction of the second solvent with the carbonaceous material well developed in graphitization is assumed to be suppressed. Further, when the donor number of the second solvent is controlled to not more than 18, the oxidative decomposition potential to the lithium electrode can be easily increased to 4 V or more, so that it is possible to manufacture a lithium secondary battery of high voltage.

Preferable second solvents are dimethyl carbonate (DMC), methylethyl carbonate (MEC), diethyl carbonate (DEC), ethyl propionate, methyl propionate, propylene carbonate (PC), gamma.-butyrolactone (γ-BL), acetonitrile (AN), ethyl acetate (EA), propyl formate (PF), methyl formate (MF), toluene, xylene and methyl acetate (MA). These second solvents may be employed singly or in a combination of two or more. More desirably, this second solvent should be selected from those having a donor number of 16.5 or less. The viscosity of this second solvent should preferably be 28 cps or less at 25° C.

The electrolytic salts to be incorporated into a non-aqueous electrolyte may be selected from a lithium salt such as lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃) and bis-trifluoromethyl sulfonylimide lithium [LiN(CF₃SO₂)₂]. Among them, LiPF₆, LiBF₄ and LiN(CF₃SO₂)₂ are preferred. The content of aforementioned electrolytic salts in the non-aqueous solvent is preferably from 0.5 to 3.5 mol/l.

For sodium batteries, the organic electrolyte may contain an alkali metal salt preferably selected from sodium perchlorate (NaClO₄), potassium perchlorate (KClO₄), sodium hexafluorophosphate (NaPF₆), potassium hexafluorophosphate (KPF₆), sodium borofluoride (NaBF₄), potassium borofluoride (KBF₄), sodium hexafluoroarsenide, potassium hexafluoroarsenide, sodium trifluoro-metasulfonate (NaCF₃SO₃), potassium trifluoro-metasulfonate (KCF₃SO₃), bis-trifluoromethyl sulfonylimide sodium (NaN(CF₃SO₂)₂), bis-trifluoromethyl sulfonylimide potassium (KN(CF₃SO₂)₂), an ionic liquid salt, or a combination thereof.

The ionic liquid is composed of ions only. Ionic liquids are low melting temperature salts that are in a molten or liquid state when above a desired temperature. For instance, a salt is considered as an ionic liquid if its melting point is below 100° C. If the melting temperature is equal to or lower than room temperature (25° C.), the salt is referred to as a room temperature ionic liquid (RTIL). The IL salts are characterized by weak interactions, due to the combination of a large cation and a charge-delocalized anion. This results in a low tendency to crystallize due to flexibility (anion) and asymmetry (cation).

A typical and well-known ionic liquid is formed by the combination of a 1-ethyl-3-methylimidazolium (EMI) cation and an N,N-bis(trifluoromethane)sulphonamide (TFSI) anion. This combination gives a fluid with an ionic conductivity comparable to many organic electrolyte solutions and a low decomposition propensity and low vapor pressure up to ˜300-400° C. This implies a generally low volatility and non-flammability and, hence, a much safer electrolyte for batteries.

Ionic liquids are basically composed of organic ions that come in an essentially unlimited number of structural variations owing to the preparation ease of a large variety of their components. Thus, various kinds of salts can be used to design the ionic liquid that has the desired properties for a given application. These include, among others, imidazolium, pyrrolidinium and quaternary ammonium salts as cations and bis(trifluoromethanesulphonyl) imide, bis(fluorosulphonyl)imide, and hexafluorophosphate as anions. Based on their compositions, ionic liquids come in different classes that basically include aprotic, protic and zwitterionic types, each one suitable for a specific application.

Common cations of room temperature ionic liquids (RTILs) include, but not limited to, tetraalkylammonium, di-, tri-, and tetra-alkylimidazolium, alkylpyridinium, dialkyl-pyrrolidinium, dialkylpiperidinium, tetraalkylphosphonium, and trialkylsulfonium. Common anions of RTILs include, but not limited to, BF₄⁻, B(CN)₄⁻, CH₃BF₃⁻, CH₂CHBF₃⁻, CF₃BF₃⁻, C₂F5BF₃⁻, n-C₃F₇BF₃⁻, n-C₄F₉BF₃⁻, PF₆⁻, CF₃CO₂⁻, CF₃SO₃⁻, N(SO₂CF₃)₂⁻, N(COCF₃)(SO₂CF₃)⁻, N(SO₂F)₂⁻, N(CN)₂⁻, C(CN)₃⁻, SCN⁻, SeCN⁻, CuCl₂⁻, AlCl₄⁻, F(HF)_{2.3}⁻, etc. Relatively speaking, the combination of imidazolium- or sulfonium-based cations and complex halide anions such as AlCl₄⁻, BF₄⁻, CF₃CO₂⁻, CF₃SO₃⁻, NTf₂⁻, N(SO₂F)₂⁻, or F(HF)_{2.3}⁻ results in RTILs with good working conductivities.

RTILs can possess archetypical properties such as high intrinsic ionic conductivity, high thermal stability, low volatility, low (practically zero) vapor pressure, non-flammability, the ability to remain liquid at a wide range of temperatures above and below room temperature, high polarity, high viscosity, and wide electrochemical windows. These properties, except for the high viscosity, are desirable attributes when it comes to using an RTIL as an electrolyte ingredient (a salt and/or a solvent) in a battery.

There is no limitation on what kinds of electrolytes or cathodes that can be used to work with the presently disclosed lithium-ion or sodium-ion batteries.

The following examples are used to illustrate some specific details about the best modes of practicing the instant invention and should not be construed as limiting the scope of the invention.

### Example 1: Preparation of Si-Loaded Graphene Balls From Partially Graphitized MCMB

Green (un-graphitized) MCMB particles were used as a starting material. We used two different amounts of starting material (400 g and 100 g). Other than this difference in starting amounts, all other variables were the same in the following activation procedures. The particles were impregnated with zinc chloride (ZnCl₂) at 1:1 wt. ratio and were kept at 80° C. for 14 h. Heat treatments were then carried out under constant nitrogen flow (5 l/h). The heat treatment temperature was raised at 4° C./min up to 600° C., which was maintained for 3 h. The samples were then washed to remove excess reagent and dried at 110° C. for about 3 h. The resulting samples were labeled as CA-600 (chemically activated at 600).

A portion of these samples was then also submitted to a partial graphitization treatment by raising the temperature 1,550° C. at a rate of 25° C./min under nitrogen flow and then stayed at 1,550° C. for two hours. These samples were then labeled as CA-1550. It was observed that combined chemical activation and partial graphitization treatments led to a higher porosity level and slightly higher pore sizes that are more readily accessible to sulfur infiltration. In addition, the electrical conductivity and thermal conductivity were significantly increased. Combined X-ray diffraction, SEM and TEM studies indicate the formation of domains of graphene planes dispersed in a substantially disordered carbon matrix.

Silicon infiltration was conducted by placing the porous graphene balls in a rotating chamber in a furnace heated to above 450-850° C. A stream of silane-N₂ mixture gas was then introduced into the chamber and directed to infiltrate into pores of the graphene balls. Si (typically having a thickness of 4-15 nm) was found to deposit in the pores of the graphene balls.

To deposit Si particles in the pores of the graphene balls, CVD of SiH₄ was conducted. For instance, 0.5 g of activated carbon was placed into a quartz-tube furnace. Then, the sample was heated to 500° C. under Ar flow. When the target temperature was reached, 30 cc/min of SiH₄ (9.99%, diluted with H₂) was injected into the quartz-tube furnace and maintained for 60 min. After the reaction, the injection gas was changed to Ar flow, and then the furnace was cooled to room temperature.

### Example 2: Preparation of Si-Loaded Graphene Balls Encapsulated by an Ion-Conducting Polymer

The graphene balls loaded with Si (prepared in Example 1) were encapsulated by an ion-conducting polymer, poly(vinylidene fluoride)-hexafluoropropylene (PVDF-HFP) using spray-drying and dip coating separately. First, PVDF-HFP was dissolved in acetone to form a polymer solution. In the dip-coating procedure, a sample featuring a porous metal mesh cage containing sulfur-loaded graphene balls therein was immersed in the polymer solution for 1-10 minutes and then retreated and let dry in a slightly heated vacuum chamber. The graphene balls were coated with a thin layer of PVDF-HFP with a thickness in the range of 15 nm to 36 nm.

Separately, Si-loaded graphene balls were dispersed in the PVDF-HFP/acetone solution to form a slurry, which was then spray-dried to form a polymer-encapsulated graphene balls. The encapsulating shells were found to be typically from 6 to 16 nm.

### Example 3: Preparation of Si-Loaded Graphene Balls From Partially Graphitized Bio-Char

In chemical activation, inorganic compounds or salts, such as zinc chloride, sodium hydroxide, potassium hydroxide, or phosphoric acid, can be used to convert the biochar to activated carbon. In this study, potassium hydroxide was used as the activating agent and the desired nitrogen flow rate, potassium hydroxide-to-biochar mass ratio, and activation temperature were varied. Activation temperatures were set between 550° C. and 800° C., along with nitrogen flow rates ranging from 80 cc/min to 250 cc/min, and mass ratios from 0.25 to 3. Chemical activation was achieved by exposing biochar to the desired amount of potassium hydroxide mixed with 100 mL of water, and allowing the mixture to sit for 2 hours at room temperature. Following this, samples were dried overnight at a temperature of 120° C. Subsequently, 200 grams of the dried sample was put in a fixed-bed reactor and heated to a temperature of 300° C. at a rate of 3 °C/min, it was then held at 300° C. for 1 hour. Following the temperature hold at 300° C., the temperature was further increased at a rate of 3° C./min until it achieved the desired activation temperature. Once the desired temperature was reached, activation was allowed to proceed for 2 hours. The products were washed with water, then hydrogen chloride, and then distilled water to remove unwanted compounds and salts. Finally, the sample was dried for 12 hours at a temperature of 110° C. The activated carbon products with an activation temperature lower than 800° C. were characterized with a low electric conductivity, low thermal conductivity, and low structural integrity (quite fragile). These properties are not favorable to the use of these porous carbon particles as a host for sulfur for the alkali metal-sulfur battery application.

We have observed that increases in the carbonization and/or activation temperature above 1,500° C. effectively induced the formation of larger condensed aromatic networks arranged in interconnected conducting domains, which are essentially graphene planes (typically 1-9 planes stacked together, but could be larger in number) dispersed in some disordered carbon structure. The degree of graphitization can reach approximately 45% when the partial graphitization temperature was up to 2,000° C.. Again, the electrical conductivity and thermal conductivity were significantly increased. Combined X-ray diffraction, SEM and TEM studies indicate the formation of domains of graphene planes dispersed in a substantially disordered carbon matrix.

To deposit Si particles in the pores of the graphene balls, CVD of SiH₄ was conducted. For instance, 0.5 g of activated carbon was placed into a quartz-tube furnace. Then, the sample was heated to 500° C. under Ar flow. When the target temperature was reached, 30 cc/min of SiH₄ (9.99%, diluted with H₂) was injected into the quartz-tube furnace and maintained for 60 min.

After the reaction, the injection gas was changed to Ar flow, and then the furnace was cooled to room temperature.

### Example 4: Production of Porous Graphene Particles (Graphene Balls) From Partially Graphitized Petroleum-Based Needle Coke and Si Deposition From Cyclohexasilane

Needle coke (supplied from Conoco-Phillips) was subjected to chemical activation and partial graphitization following the procedures described in Example 3. The graphene balls produced from this process typically have a high level of porosity (lower physical density).

After the porous graphene balls were prepared, they were impregnated with a liquid silane, cyclohexasilane (CHS, Si₆H₁₂), which maintains a low vapor pressure and is stable in ambient light. CHS is herein used for the solution-based synthesis of functional Si coating or particles. The CHS undergoes a ring-opening polymerization when exposed to heat or UV light, with thermal annealing transforming the polyhydrosilane to silicon. In the present study, porous graphene balls were immersed in liquid silane (CHS) at room temperature under simultaneous UV irradiation from a 500 W HgXe lamp to initiate ring-opening polymerization into polysilane, denoted [—Si(H₂)—]n. Presumably, some of the UV-initiated reactive species permeated into pores of the graphene balls. The porous graphene balls containing polysilane in the pores were then annealed at 400° C. for 1 h in a vacuum oven to transform the polysilane into amorphous silicon coating or particles through the elimination of excess hydrogen. The particulates were then subjected to tube furnace annealing at 550° C. for 1 h in a nitrogen atmosphere to induce further desorption of hydrogen, followed by a higher temperature heat treatment at 950° C. for 1 h.

### Example 5: Production of Activated Carbon by Chemical Activation of MCMBs by ZnCl₂, Followed by Deposition of Si and Sn in the Pores

We used two different amounts of starting material (400 g and 100 g). Other than this difference in starting amounts, all other variables were the same in the following activation procedures. The particles were impregnated with zinc chloride (ZnCl₂) at 1:1 wt. ratio and were kept at 80° C. for 14 h. Heat treatments were then carried out under constant nitrogen flow (5 l/h). The heat treatment temperature was raised at 4° C./min up to 500° C., which was maintained for 3 h. The samples were then washed to remove excess reagent and dried at 110° C. for about 3 h. The resulting samples were labeled as CA (chemically activated only). Part of these samples was then also submitted to physical activation. Temperature was raised to 900° C. at a rate of 25° C./min, under nitrogen flow. At 900° C., the samples were then contacted with steam (0.8 kg/h) for 30 min. These samples were then labeled as CAPA (both chemically and physically activated). It was observed that combined physical and chemical activation treatments led to a higher porosity level and slightly higher pore sizes that are more readily accessible to liquid electrolyte. Some of the materials were further heat treated at 1,600° C. for 2-6 hours to accomplish a desired degree of graphitization.

The Si deposition of partially graphitized and non-graphitized sample was similar to that described in Example 1. Impregnation of tin (Sn) was conducted using a simple melt impregnation procedure at a temperature higher than the melting point (232° C.) of Sn.

### Example 6: Chemical Activation of MCMBs by KOH, NaOH, and Their Mixtures and Deposition of Si and SnO₂ in the Pores

In this example, several MCMB samples were separately mixed with KOH, NaOH, and their mixtures (30/70, 50/50, and 70/30 weight ratios) to obtain reactant blends. The blends were then heated to a desired temperature (in the range of 700-950° C.) and maintained at this temperature for 0.5-12 hours to produce various activated MCMB samples. The resulting structures vary with the previous heat treatment history of MCMBs, activation temperature, and activation time. The following observations were made:
1) The maximum heat treatment temperature (Tₘₐₓ) the MCMBs saw prior to the chemical activation dictates the number of graphene planes in graphene domains ligaments and the maximum porosity level of the resulting porous particles. A Tₘₐₓ in the range of 500-1,500° C. tends to result in thinner pore walls (0-3 graphene planes); Tₘₐₓ of 1,500-2,500° C. leads to 3-7 graphene planes in graphene domains; and Tₘₐₓ of 2,500-3,000° C. leads to 7-20 graphene planes in graphene domains. A higher Tₘₐₓ for a longer period of heat treatment time leads to a higher degree of graphitization of MCMBs and progressively smaller amount of amorphous zones left in the MCMB.
2) Given the same MCMBs, a higher activation temperature and longer activation time lead to a higher porosity level, but the number of graphene planes in graphene ligaments appears to be relatively independent of the activation time and temperature.
3) An excessively long activation time (e.g. >3 hours) would consume too much carbon material, reducing the production yield of the 3D graphene skeleton particles.

The process of depositing Si in the pores was similar to those discussed in Example 2. Subsequently, chemical lithiation of the Si coating was conducted by using 1 M lithium-biphenyl (Li-Bp)/tetrahydrofuran (THF) solution as the prelithiation reagent. Biphenyl (Bp) was chosen because of its unique chemical/electrochemical behavior in different solvents. In ether solvents (e.g., dimethoxyethane (DME) and THF), it can react with lithium metal and form a strong reducing reagent of Li-Bp. Moreover, the resulting Li-Bp solution is relatively stable toward air and moisture, which is critical to the prelithiation in ambient air. Prelithiation was conducted by simply immersing the Si-containing porous MCMB particles in the prelithiation reagent at room temperature for 10-100 minutes. The prelithiated Si-containing carbon particles were subsequently immersed in a liquid polymer solution including PVDF-HFP dissolved in NMP and then retreated from the liquid solution and dried in a vacuum oven at 60° C. overnight to obtain surface-protected prelithiated anode particulates.

Tin oxide (SnO₂) nano particles were obtained by the controlled hydrolysis of SnCl₄·5H₂O with NaOH using the following procedure: SnCl₄·5H₂O (0.95 g, 2.7 m-mol) and NaOH (0.212 g, 5.3 m-mol) were dissolved in 50 mL of distilled water each. The NaOH solution was added drop-wise under vigorous stirring to the tin chloride solution at a rate of 1 mL/min. This solution was homogenized by sonication for 5 min and then graphene balls were added into the solution. Subsequently, the resulting hydrosol was reacted with H₂SO₄. To this mixed solution, few drops of 0.1 M of H₂SO₄ were added to flocculate the product. SnO₂ nano particles were mostly formed inside the pores, but some precipitated out of the graphene balls. The desired SnO₂-impregnated graphene balls were collected by centrifugation, washed with water and ethanol, and dried in vacuum. The dried product was heat-treated at 400° C. for 2 h under Ar atmosphere.

The high-elasticity polymer matrix for protecting SnO₂ nano particle-containing graphene balls was based on a mixture of Poly(propylene glycol) dimethacrylate and methyl benzoylformate (MBF). Upon spray-drying, the resulting micro-droplets were heated and exposed to UV at 65° C. for 2 hours to produce composite particulates containing SnO₂ nano particle-containing graphene balls dispersed in a cross-linked compound of Poly(propylene glycol) dimethacrylate.

1. A powder mass comprising multiple porous graphene balls or particulates for use in a lithium-ion battery or sodium-ion battery, wherein at least one or all of said graphene balls or particulates has a diameter from 100 nm to 20 μm and comprises (i) pores and pore walls therein, wherein said pore walls have a wall thickness from approximately 0.34 nm to 100 nm, and (ii) an anode active material residing in said pores or supported by said pore walls, and wherein (a) at least one of said pore walls comprises one or a plurality of graphene domains dispersed in a disordered or amorphous carbon phase and said domain consists essentially of 1-100 graphene planes; and (b) said anode active material is in a form of particles or coating having a diameter or thickness from 0.5 nm to 10 μm, and in an amount of 0.1% to 95% of the total particulate weight.

2. The powder mass of claim 1, wherein said graphene domains contain from 1 to 20 stacked graphene planes having an inter-plane spacing d₀₀₂ from 0.3354 nm to 2.0 nm as measured by X-ray diffraction and said graphene planes comprise 0% to 25% by weight of non-carbon elements.

3. The powder mass of claim 2, wherein said non-carbon elements are selected from the group consisting of O, H, N, F, Cl, Br, B, S, P, and combinations thereof.

4. The powder mass of claim 1, wherein said anode active material comprises clusters having a diameter or thickness from 0.5 to 10 nm that are coated on pore walls.

5. The powder mass of claim 1, wherein said anode active material is selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobium oxide, lithium-containing titanium oxide, lithium transition metal oxide, ZnCo₂O₄; (f) carbon or graphite particles; (g) prelithiated versions thereof; and (h) combinations thereof.

6. The powder mass of claim 1, wherein the pores have a pore size from 5 nm to 10 μm and the porous graphene balls have a porosity level from 10% to 99% prior to hosting said anode active material.

7. The powder mass of claim 1, wherein the pores are interconnected and the porous graphene balls have a porosity level from 50% to 95%.

8. The powder mass of claim 1, wherein one or a plurality of anode active material particles, having a total volume Va, resides in a pore having a pore volume Vp and the Vp/Va ratio is from 1.2 to 5.0, preferably from 1.5 to 4.0.

9. The powder mass of claim 1, wherein said graphene ball is encapsulated or coated with a coating material that is electron-conducting, ion-conducting, or both electron-and ion-conducting.

10. The porous graphene particulate of claim 9, wherein said electron-conducting material is selected from an intrinsically conducting polymer, a pitch, an amorphous carbon, a metal, or a combination thereof.

11. The powder mass of claim 10, wherein said intrinsically conducting polymer is selected from polyacetylene, polythiophene, poly(3-alkylthiophenes), polypyrrole, polyaniline, polyfuran, a bi-cyclic polymer, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof.

12. The powder mass of claim 10, wherein said lithium ion-conducting material is selected from a material comprising Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, x=0-1, y=1-4.

13. The powder mass of claim 10, wherein said lithium ion-conducting material contains a lithium salt selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato) borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, or a combination thereof.

14. The powder mass of claim 10, wherein said lithium ion- or sodium ion-conducting material comprises a lithium ion-conducting or sodium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, poly bis-methoxy ethoxyethoxide-phosphazenex, polyphosphazene, cyanoethyl poly(vinyl alcohol), a pentaerythritol tetra-acrylate-based polymer, an aliphatic polycarbonate, a single Li-ion conducting solid polymer, poly(ethylene glycol) diacrylate, poly(ethylene glycol) methyl ether acrylate, polyurethane, polyurethane-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a semi-penetrating network thereof, a sulfonated derivative thereof, or a combination thereof.

15. The powder mass of claim 1, wherein said graphene ball or particulate, when measured without said anode active material, has a density from 0.005 to 1.7 g/cm³ and a specific surface area from 50 to 2,630 m²/g.

16. The powder mass of claim 1, wherein said stacked graphene planes have an inter-plane spacing d₀₀₂ from 0.34 nm to 0.6 nm as measured by X-ray diffraction.

17. A lithium-ion or sodium-ion battery anode comprising the powder mass of claim 1.

18. The anode of claim 17 comprising a binder.

19. A lithium-ion or sodium-ion battery comprising a cathode, the anode of claim 17, and an electrolyte in ionic contact with both said cathode and said anode.

20. A process for producing the powder mass of claim 1, the process comprising:
(A) producing porous graphene balls, having pores and pore walls therein, by activating, carbonizing, and partially graphitizing a carbonaceous feedstock selected from biochar, bio-pitch, petroleum pitch, coal tar pitch, petroleum coke, coal-derived coke, carbonized pitch, meso-phase pitch, meso-carbon micro-beads (MCMB), needle coke, soft carbon, hard carbon, activated carbon, carbon fibers, or a combination thereof, wherein partial graphitization refers to a product either (i) exhibiting a degree of graphitization, g, less than 100% but greater than 0%, wherein g=(3.440−d₀₀₂)/(3.440−3.354), where 3.440 is a reference inter-planar spacing in a graphite material with a turbostratic structure; d₀₀₂, with a unit Angstrom (1 Å=0.1 nm), is the value of interlayer spacing of a partially graphitized product obtained by X-ray diffraction and d₀₀₂ is no greater than 3.440 Å, or (ii) having a interlayer spacing in the range of 3.440 <d₀₀₂<20 Å, wherein the carbonaceous feedstock is in a particle form having a size smaller than 1 mm, preferably smaller than 100 μm, before or after the activating, carbonizing, and partially graphitizing procedure; and
(B) impregnating or infiltrating an anode active material into pores of said porous graphene balls to form said powder mass

21. The process of claim 20, wherein Step (A) of producing graphene balls comprises a procedure selected from (i) carbonization of a feedstock followed by activation and partial graphitization; (ii) concurrent carbonization and activation followed by partial graphitization; or (iii) carbonization and partial graphitization followed by activation, wherein the degree of graphitization prior to activation is from 10% to 70%.

22. The process of claim 20, wherein said step (B) of impregnating or infiltrating an anode active material into pore comprises a procedure selected from physical vapor deposition, plasma-enhanced physical vapor deposition, chemical vapor deposition, plasma-enhanced chemical vapor deposition, electrochemical deposition, liquid solution deposition, sputtering, or a combination thereof.

23. The process of claim 20, wherein the process further comprises a step of encapsulating the graphene balls, after step (B), with a coating material that is electron-conducting, ion-conducting, or both electron-and ion-conducting.

24. The process of claim 23, wherein the encapsulating step comprises a procedure selected from spray drying, spray cooling, pan-coating, air-suspension coating, fluidized-bed coating, freeze-drying, centrifugal extrusion, vibration nozzle coating, hydrothermal encapsulation, supercritical fluid coating, or in-situ polymerization.

25. The process of claim 20, wherein the process further comprises a step of incorporating the powder mass in an anode (negative electrode) for a lithium-ion or sodium-ion battery.
